(19) United States
(12) Patent Application Publication
(10) Pub. No.: US 2009/0261547 A1
(43) Pub. Date: Oct. 22, 2009

(54) Ross dolly trolley

(76) Inventor: Albert W. Ross, Waterford, MI (US)

Correspondence Address: Albert Ross, 43 Baycrest, Waterford, MI, 48327, US

(21) Appl. No.: 12/148,543

(22) Filed: Apr. 21, 2008

(51) Int. Cl. B62B 3/02

(52) U.S. Cl. 280/47.2

(57) ABSTRACT

The Ross Dolly Trolley is a modified hand truck or furniture cart. It is modified by adding four keel or thimble wheels (guide wheels) to the inside of the frame that will allow it to track the rails of an extension ladder. A pivot pin is inserted through the step of the ladder and tied down. It can then be used in conjunction with block and tackle to load and unload items into or out of a pickup truck, or other cargo vehicles. An extension ladder is pivotally mounted on a cargo bed of a truck, by inserting a pin through a step of the ladder. Each side of the pin is then strapped to the truck. A pulley system (block and tackle) is hooked to the top of the ladder as well as the loaded dolly, by pulling a rope through the pulleys, the dolly trolley will climb the ladder when it reaches a certain point the ladder will pivot, depositing the loaded dolly trolley into the truck.

The present invention is a Ross Dolly Trolley, which is made of the following elements:
(1) Referring to FIGS. 1 and 2. A fairly rectangular tubular steel frame. This frame will also have a thin steel plate mounted at one end and at the opposite side a handle(s). This plate will be used to slide under items for transport, when the frame is standing upright (10). On the side of the handle an eyebolt will be positioned in the center (45). This eyebolt will be used for hooking up the block and tackle.
(2) Referring to FIGS. 1 and 2. Four wheels (casters or rollers) welded on the outside corners of the steel frame that allow the frame to roll but also allow the frame to stand upright on two wheels (20, 40).
(3) Referring to FIGS. 1 and 2. Additional thimble or keel wheels (guide or tracking wheels) are welded inside the corner or outer wheels (40).
(4) Referring to FIGS. 3 and 4. Block and tackle (60) with rope and or cable (70).
(5) Referring to FIGS. 3, 4 and 5. An extension ladder (50).
(6) Referring to FIGS. 3, 4 and 5. A pivot pin or bolt (100), which is a strong tubular steel piece of steel. This is used to go through the step of the ladder at the end of the tailgate. It is then tied or strapped (75) to the truck, allowing the ladder to pivot, but keeping the ladder from sliding up or down as well as right and left.
(7) Referring to FIG. 5. A pivot block (110) which is just a block of wood or other material about the width of the extension ladder.
(8) Referring to FIGS. 1 and 2. The outer wheels and keel or thimble wheels may be welded below in various positions on or below the main frame, these wheels may swivel.
(9) Referring to FIG. 3. The block and tackle (60) may come in multiple pulley combinations.

It should be noted that the frame (and its components) as well as the pivot pin or bolt can be made of various materials such as aluminum, metal allow or any other sufficiently resilient material, but steel is preferable. These components will be assembled by various means, such as but not limited to welding, and or, nuts and bolts.

The handle could be made up of steel with a rubber sleeve, but not limited to such material.

The wheels (casters) and thimble wheels can be made of rubber or nylon, but not limited to such material. A steel or metal wheel would also work.

The pivot block can be made of, but not limited to, wood plastic or steel. This is a devise that's main purpose is to raise the extension ladder slightly off the tailgate of a truck. It should also be noted in certain applications, it may not be needed.

While the present invention has been described in terms of specific embodiments, it is to be understood that the invention is not limited to these disclosed embodiments. This invention may be embodied in many different forms and should not be construed as limited to the embodiments set forth herein; rather, these embodiments are provided by way of Illustration only and so that this disclosure will be thorough, complete and will fully covey the full scope of the invention to those skilled in art. Indeed, many modifications and other embodiments of the invention will come to mind of those skilled in the art to which this invention pertains, and which are intended to be and are covered by both this disclosure, the drawings and the claims.

### FIGURE DESCRIPTIONS

FIG. 1 is a perspective view of a two wheel hand truck and four wheel furniture cart with guide wheels of the invention installed thereon, forming a Ross Dolly Trolley of the invention;

FIG. 2 is a perspective view of loading an object for transport and laying the trolley down;

FIG. 3 is a perspective view of the invention, illustrating a ladder with pulley and rope;

FIG. 4 is a side view of the invention, illustrating the ladder in a leaning position with pivot pin and pivot block; and

FIG. 5 is a side view of the invention, illustrating the ladder with pivot pin and pivot block.

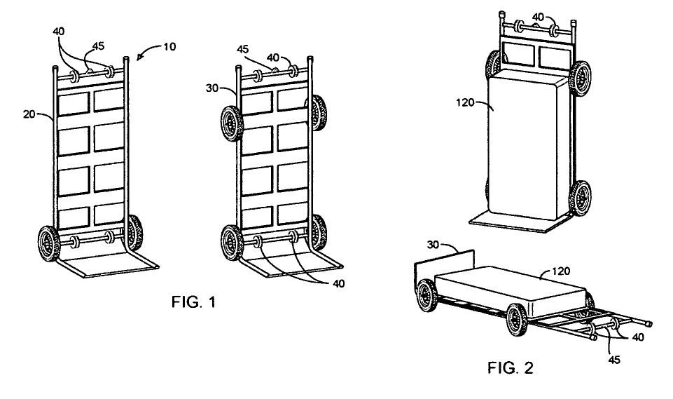

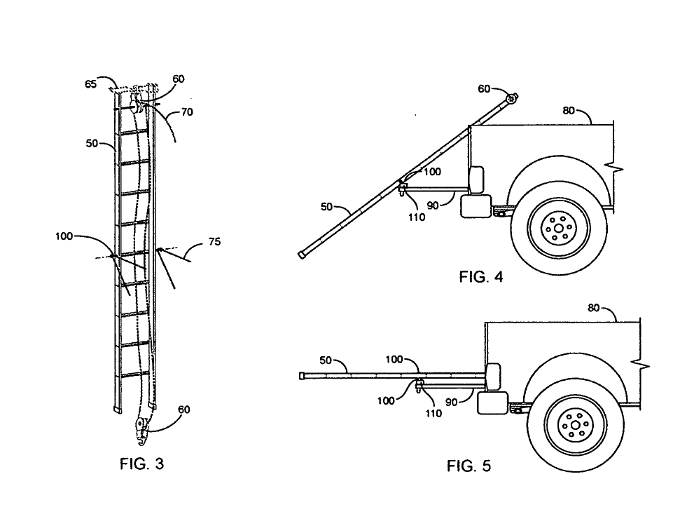

### NUMBER DESCRIPTION LIST

10 is a Ross Dolly Trolley of the present invention.
20 is a two wheel hand truck.
30 is a four wheel furniture cart.
40 is a guide wheel.
45 is a guide wheel.
50 is a ladder.
60 is a pulley with hook.
65 is a tie off rope.
70 is a rope.
75 is a tie down.
80 is a pickup truck.
90 is a tail gate of pickup truck.
100 is a pivot pin.
110 is a pivot block.
120 is an object for transport.

What is claimed is:

1. A Ross Dolly Trolley comprising: A metal rectangular frame that has a metal plate welded to the short side of the frame, as well as a handle and eyebolt welded on the opposite side. Four wheels or casters are welded to the frame, allowing the frame to roll, as well as allowing the frame to stand on two wheels. In addition four guides are welded inside the original wheels allowing it to track the rails of a ladder. It also incorporates a pivot pin through the ladder allowing it be tracked and pivot. Included in this system is a block and tackle that is used to pull the metal frame up the ladder.

2. The invention of claim 1 wherein the frame, steel plate, wheels handle are bolted, screwed or brazed.

3. The invention of claim 1 where in the frame incorporates additional wheels, casters or guide wheels.

4. The invention of claim 1 wherein the frame is adjustable or telescopic.

5. The invention of claim 1 wherein there are multiple eyebolts.

6. The invention of claim 1 wherein the handles is incorporated in the frame itself.

7. The invention of claim 1 wherein the frame has a metal platform welded, bolted or screwed (but not limited to) frame.

8. The invention of claim 1 wherein the outer wheels and keel or thimble (guide wheels) are mounted in various positions on or below the main frame.

9. The invention of claim 1 wherein the outer wheels swivel and or are adjustable.

10. The invention of claim 1 wherein the block and tackle come in multiple pulley combinations.

11. The invention of claim 10 where in a motor is used in conjunction with the block and tackle.
